(19) United States
(12) Patent Application Publication
(10) Pub. No.: US 2022/0327558 A1
(43) Pub. Date: Oct. 13, 2022

(54) Device, Method, and System for Contribution Management

(71) Applicant: Hitachi, Ltd., Tokyo (JP)

(72) Inventors: Jayesh GUNTUPALLI, Tokyo (JP); Shin TEZUKA, Tokyo (JP); Hatem ELSERAFY, Tokyo (JP); Santosh MAURYA, Tokyo (JP); Yusuke ARAI, Tokyo (JP); Kentarou WATANABE, Tokyo (JP); Hiroshi NAKAGOE, Tokyo (JP); Yoji OZAWA, Tokyo (JP)

(21) Appl. No.: 17/715,264

(22) Filed: Apr. 7, 2022

(30) Foreign Application Priority Data
Apr. 13, 2021 (JP) 2021-067732

(51) Int. Cl. G06Q 30/02

(52) U.S. Cl. CPC G06Q 30/0201; G06Q 30/0202

(57) ABSTRACT

Aspects relate to contribution management for quantifying the contribution of solution owners to digital ecosystems based on the growth progress of the digital ecosystem. A contribution management device for managing a contribution of a solution owner in a digital ecosystem, including a data collection unit to collect a first set of solution performance metrics for a first digital solution and a set of ecosystem key performance indicators, a contribution measurement unit to calculate a first contribution score for the first digital solution, and a suggestion unit to generate a set of recommended actions for increasing growth of the digital ecosystem. The contribution measurement unit further includes a growth assessment unit to generate a set of growth progress data for the digital ecosystem and a dynamic weight calculation unit to calculate the first set of metric weights.

### CROSS-REFERENCE TO RELATED APPLICATIONS

The present application claims priority to Japanese Patent Application No. 2021-067732, filed Apr. 13^{th}, 2021. The contents of this application are incorporated herein by reference in their entirety.

### BACKGROUND OF THE INVENTION

The present disclosure generally relates to digital ecosystem management, and more particularly relates to managing the contribution of a solution owner to a digital ecosystem.

### SUMMARY OF THE INVENTION

In recent years, with the increase of digital service based enterprises, digital ecosystems for managing solutions provided by these digital services are increasing in number and complexity. In general, digital ecosystems refer to a distributed, adaptive, open socio-technical system with properties of self-organization, scalability and sustainability for facilitating the management of solutions between solution owners and customers. A digital ecosystem may include solutions, applications, and systems, along with external trading partners, suppliers, customers, third-party data service providers, and all their respective technologies. The digital ecosystem is a dynamic, interconnected network that facilitates reliable communication among customers and trading partners.

Here, a “solution” refers to a set of software or a set of services and programs for execution on a computer in order to perform a task, solve a problem, or achieve a goal. Accordingly, the “solution owner” refers to the party responsible for developing, maintaining, and improving the solution. The solution owner may submit one or more solutions to the digital ecosystem to be provided to customers as a service. The digital ecosystem may be managed by a platform manager who oversees the organization, management, and growth of the digital ecosystem.

Conventionally, techniques for evaluating the performance of solution users have been proposed. The performance ratings of solution owners with respect to project activities are calculated, and the performance results are used to reward and incentivize the solution owners.

As an example, U.S. Pat. No. 10,423,916B1 (Patent Document 1) discloses “A computer implemented method for generating a performance rating for a developer may include monitoring developer activities to obtain near real-time activity data; exploring the near real-time activity data to identify entities; structuring the near real-time activity data into data-frame objects; performing a feature engineering procedure to measure representative behaviors of the developer and performing a performance analysis to produce performance rating of the developer.”

Patent Document 1 discloses a technique for generating performance ratings for a solution owner based on real-time data collected for activities performed by the solution owner. Additionally, activities for enhancing the performance of the solution owner are suggested.

The technique disclosed in Patent Document 1, however, does not take into account the growth progress of the digital ecosystem. More particularly, in Patent Document 1, performance ratings for a solution owner are generated based on the state of the digital ecosystem at a particular point in time, and the past and future growth of the digital ecosystem are not considered. Further, in Patent Document 1, suggested activities are suggested to the solution owner for increasing his or her performance rating, but these suggested activities do not directly facilitate the continued growth of the digital ecosystem as a whole.

Accordingly, it is an object of the present disclosure to provide a device, method, and system for contribution management that can quantify the contribution of solution owners to digital ecosystems in consideration of the growth progress of the digital ecosystem, and generate recommended actions that directly facilitate the continued growth of the digital ecosystem as a whole.

One representative example of the present disclosure relates to a contribution management device for managing a contribution of a solution owner in a digital ecosystem, the contribution management device including a data collection unit configured to collect a first set of solution performance metrics for a first digital solution submitted to the digital ecosystem by a solution owner, and collect, from a platform manager of the digital ecosystem, a set of ecosystem key performance indicators that indicate operational targets for the digital ecosystem; a contribution measurement unit configured to calculate a first contribution score for the first digital solution based on the first set of solution performance metrics and a first set of metric weights for the first set of solution performance metrics; and a suggestion unit configured to generate, based on the first contribution score and the set of ecosystem key performance indicators, a set of recommended actions for increasing growth of the digital ecosystem, and output the set of recommended actions, wherein the contribution measurement unit further includes a growth assessment unit configured to generate a set of growth progress data for the digital ecosystem based on the first set of solution performance metrics and the set of ecosystem key performance indicators, and a dynamic weight calculation unit configured to calculate the first set of metric weights based on the set of growth progress data.

According to the present disclosure it is possible to provide a device, method, and system for contribution management that can quantify the contribution of solution owners to digital ecosystems in consideration of the growth progress of the digital ecosystem, and generate recommended actions that directly facilitate the continued growth of the digital ecosystem as a whole.

Problems, configurations, and effects other than those described above will be made clear by the following description in the embodiments for carrying out the invention.

### BRIEF DESCRIPTION OF THE DRAWINGS

FIG. 1 is a block diagram illustrating an example computing architecture for executing the embodiments of the present disclosure.

FIG. 2 is a block diagram illustrating an example configuration of a contribution management system according to embodiments of the present disclosure.

FIG. 3 is a block diagram illustrating the flow of data within the contribution management system, according to embodiments of the present disclosure.

FIG. 4 illustrates an example configuration of a solution performance metrics table according to embodiments of the present disclosure.

FIG. 5 illustrates an example configuration of a KPIs table according to embodiments of the present disclosure.

FIG. 6 illustrates an example configuration of a growth progress table according to embodiments of the present disclosure.

FIG. 7 illustrates an example configuration of a metric weights table according to embodiments of the present disclosure.

FIG. 8 illustrates an example configuration of a contribution score table according to embodiments of the present invention.

FIG. 9 illustrates an example configuration of a solution owner action table according to embodiments of the present disclosure.

FIG. 10 illustrates an example configuration of a recommended KPIs table according to the embodiments of the present disclosure.

FIG. 11 is a flowchart illustrating the flow of a metrics and KPI collection process performed by the metrics and KPI collection unit according to the embodiments of the present disclosure.

FIG. 12 is a flowchart illustrating the flow of a growth assessment process performed by the growth assessment unit according to the embodiments of the present disclosure.

FIG. 13 is a flowchart illustrating the flow of a dynamic weight calculation process performed by the dynamic weight calculation unit according to embodiments of the present disclosure.

FIG. 14 is a flowchart illustrating the flow of a scoring process performed by the score calculation unit according to embodiments of the present disclosure.

FIG. 15 is a flowchart illustrating the flow of a solution owner action and KPI suggestion process performed by the solution owner action and KPI suggestion unit according to embodiments of the present disclosure.

FIG. 16 illustrates a solution owner interface according to embodiments of the present disclosure.

FIG. 17 illustrates a platform manager interface according to embodiments of the present disclosure.

### DETAILED DESCRIPTION

Hereinafter, embodiments of the present invention will be described with reference to the Figures. It should be noted that the embodiments described herein are not intended to limit the invention according to the claims, and it is to be understood that each of the elements and combinations thereof described with respect to the embodiments are not strictly necessary to implement the aspects of the present invention.

Various aspects are disclosed in the following description and related drawings. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Further, many aspects are described in terms of sequences of actions to be performed by, for example, elements of a computing device. It will be recognized that various actions described herein can be performed by specific circuits (e.g., an application specific integrated circuit (ASIC)), by program instructions being executed by one or more processors, or by a combination of both. Additionally, the sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter.

As described herein, aspects of the present disclosure relate to measuring the contribution of a solution owner in a digital ecosystem. The platform manager of the digital ecosystem may define target key performance indicators (hereinafter, “KPIs”) for facilitating the growth and performance of the digital ecosystem, such as the total number of solutions in the ecosystem, the profits earned by the solutions in the ecosystem, or the like. Aspects of the disclosure relate to incentivizing solution owners to perform activities that facilitate growth of the digital ecosystem and meet the target KPIs set by the platform manager. These activities of the solution owners may include developing new solutions, maintaining existing solutions, proposing new solutions, or the like.

Solution owners may develop and submit solutions to the digital ecosystem. Aspects of the disclosure relate to quantifying the contribution of the solution owner in the form of a contribution score. This contribution score is calculated by considering a set of solution performance metrics for the solution and a set of metric weights. The set of solution performance metrics include characteristics of the solution that indicate information about the performance and usage of a particular solution. Examples of the set of solution performance metrics can include the total number of solutions in the digital ecosystem, the profit earned by a particular solution, and other characteristics of the solution. The set of metric weights include weights associated with the set of solution performance metrics, and indicate the relative importance of each solution performance metric. The set of metric weights are dynamically calculated based on the growth, maturity level, target KPIs, and goals for the digital ecosystem.

The contribution score can be analyzed to generate insights and suggest activities to the solution owner in order to improve his or her contribution score and further contribute to the growth of the digital ecosystem. The past and current growth and KPIs of the digital ecosystem can be used in order to generate future KPI recommendations for the platform manager. Growth progress data may be generated for the digital ecosystem and a growth function may be created that is used as a reference for calculation of the set of metric weights.

In this way, solution owners can be incentivized to perform activities that promote the growth of the digital ecosystem, facilitating achievement of the goals set for the digital ecosystem by the platform manager.

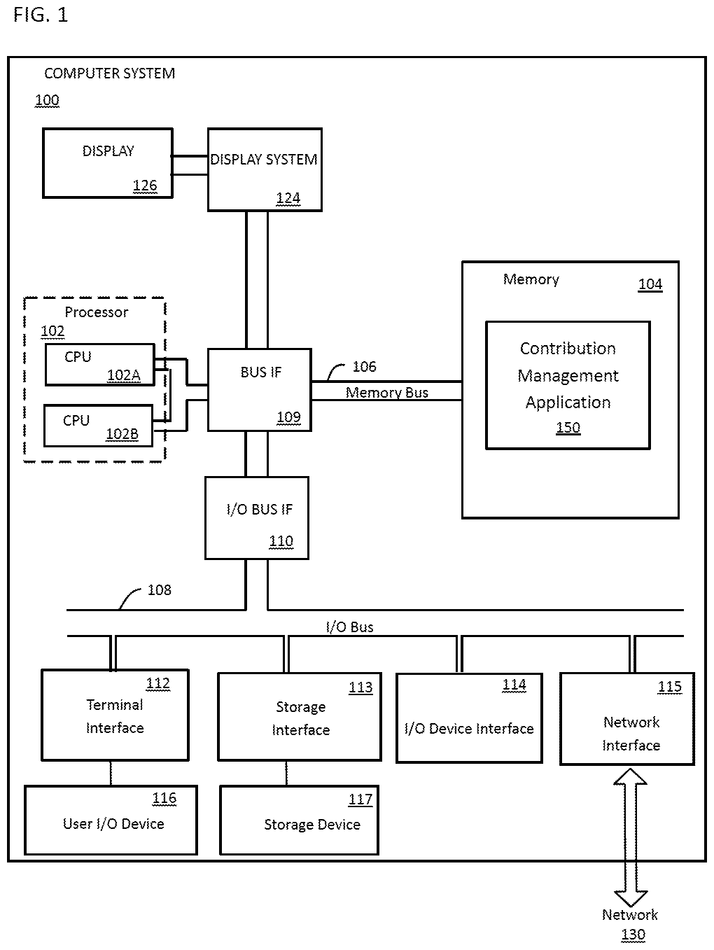

Turning now to the Figures, FIG. 1 depicts a high-level block diagram of a computer system 100 for implementing various embodiments of the present disclosure, according to embodiments. The mechanisms and apparatus of the various embodiments disclosed herein apply equally to any appropriate computing system. The major components of the computer system 100 include one or more processors 102, a memory 104, a terminal interface 112, a storage interface 113, an I/O (Input/Output) device interface 114, and a network interface 115, all of which are communicatively coupled, directly or indirectly, for inter-component communication via a memory bus 106, an I/O bus 108, bus interface unit 109, and an I/O bus interface unit 110.

The computer system 100 may contain one or more general-purpose programmable central processing units (CPUs) 102A and 102B, herein generically referred to as the processor 102. In embodiments, the computer system 100 may contain multiple processors; however, in certain embodiments, the computer system 100 may alternatively be a single CPU system. Each processor 102 executes instructions stored in the memory 104 and may include one or more levels of on-board cache.

In embodiments, the memory 104 may include a random-access semiconductor memory, storage device, or storage medium (either volatile or non-volatile) for storing or encoding data and programs. In certain embodiments, the memory 104 represents the entire virtual memory of the computer system 100, and may also include the virtual memory of other computer systems coupled to the computer system 100 or connected via a network. The memory 104 can be conceptually viewed as a single monolithic entity, but in other embodiments the memory 104 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 104 may store all or a portion of the various programs, modules and data structures for processing data transfers as discussed herein. For instance, the memory 104 can store a contribution management application 150. In embodiments, the contribution management application 150 may include instructions or statements that execute on the processor 102 or instructions or statements that are interpreted by instructions or statements that execute on the processor 102 to carry out the functions as further described below.

In certain embodiments, the contribution management application 150 is implemented in hardware via semiconductor devices, chips, logical gates, circuits, circuit cards, and/or other physical hardware devices in lieu of, or in addition to, a processor-based system. In embodiments, the contribution management application 150 may include data in addition to instructions or statements. In certain embodiments, a camera, sensor, or other data input device (not shown) may be provided in direct communication with the bus interface unit 109, the processor 102, or other hardware of the computer system 100. In such a configuration, the need for the processor 102 to access the memory 104 and the contribution management application 150 may be reduced.

The computer system 100 may include a bus interface unit 109 to handle communications among the processor 102, the memory 104, a display system 124, and the I/O bus interface unit 110. The I/O bus interface unit 110 may be coupled with the I/O bus 108 for transferring data to and from the various I/O units. The I/O bus interface unit 110 communicates with multiple I/O interface units 112, 113, 114, and 115, which are also known as I/O processors (IOPs) or I/O adapters (IOAs), through the I/O bus 108. The display system 124 may include a display controller, a display memory, or both. The display controller may provide video, audio, or both types of data to a display device 126. Further, the computer system 100 may include one or more sensors or other devices configured to collect and provide data to the processor 102.

As examples, the computer system 100 may include biometric sensors (e.g., to collect heart rate data, stress level data), environmental sensors (e.g., to collect humidity data, temperature data, pressure data), motion sensors (e.g., to collect acceleration data, movement data), or the like. Other types of sensors are also possible. The display memory may be a dedicated memory for buffering video data. The display system 124 may be coupled with a display device 126, such as a standalone display screen, computer monitor, television, or a tablet or handheld device display.

In one embodiment, the display device 126 may include one or more speakers for rendering audio. Alternatively, one or more speakers for rendering audio may be coupled with an I/O interface unit. In alternate embodiments, one or more of the functions provided by the display system 124 may be on board an integrated circuit that also includes the processor 102. In addition, one or more of the functions provided by the bus interface unit 109 may be on board an integrated circuit that also includes the processor 102.

The I/O interface units support communication with a variety of storage and I/O devices. For example, the terminal interface unit 112 supports the attachment of one or more user I/O devices 116, which may include user output devices (such as a video display device, speaker, and/or television set) and user input devices (such as a keyboard, mouse, keypad, touchpad, trackball, buttons, light pen, or other pointing device). A user may manipulate the user input devices using a user interface in order to provide input data and commands to the user I/O device 116 and the computer system 100, and may receive output data via the user output devices. For example, a user interface may be presented via the user I/O device 116, such as displayed on a display device, played via a speaker, or printed via a printer.

The storage interface 113 supports the attachment of one or more disk drives or direct access storage devices 117 (which are typically rotating magnetic disk drive storage devices, although they could alternatively be other storage devices, including arrays of disk drives configured to appear as a single large storage device to a host computer, or solid-state drives, such as flash memory). In some embodiments, the storage device 117 may be implemented via any type of secondary storage device. The contents of the memory 104, or any portion thereof, may be stored to and retrieved from the storage device 117 as needed. The I/O device interface 114 provides an interface to any of various other I/O devices or devices of other types, such as printers or fax machines. The network interface 115 provides one or more communication paths from the computer system 100 to other digital devices and computer systems; these communication paths may include, for example, one or more networks 130.

Although the computer system 100 shown in FIG. 1 illustrates a particular bus structure providing a direct communication path among the processors 102, the memory 104, the bus interface 109, the display system 124, and the I/O bus interface unit 110, in alternative embodiments the computer system 100 may include different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 110 and the I/O bus 108 are shown as single respective units, the computer system 100 may, in fact, contain multiple I/O bus interface units 110 and/or multiple I/O buses 108. While multiple I/O interface units are shown which separate the I/O bus 108 from various communications paths running to the various I/O devices, in other embodiments, some or all of the I/O devices are connected directly to one or more system I/O buses.

In various embodiments, the computer system 100 is a multi-user mainframe computer system, a single-user system, or a server computer or similar device that has little or no direct user interface, but receives requests from other computer systems (clients). In other embodiments, the computer system 100 may be implemented as a desktop computer, portable computer, laptop or notebook computer, tablet computer, pocket computer, telephone, smart phone, or any other suitable type of electronic device.

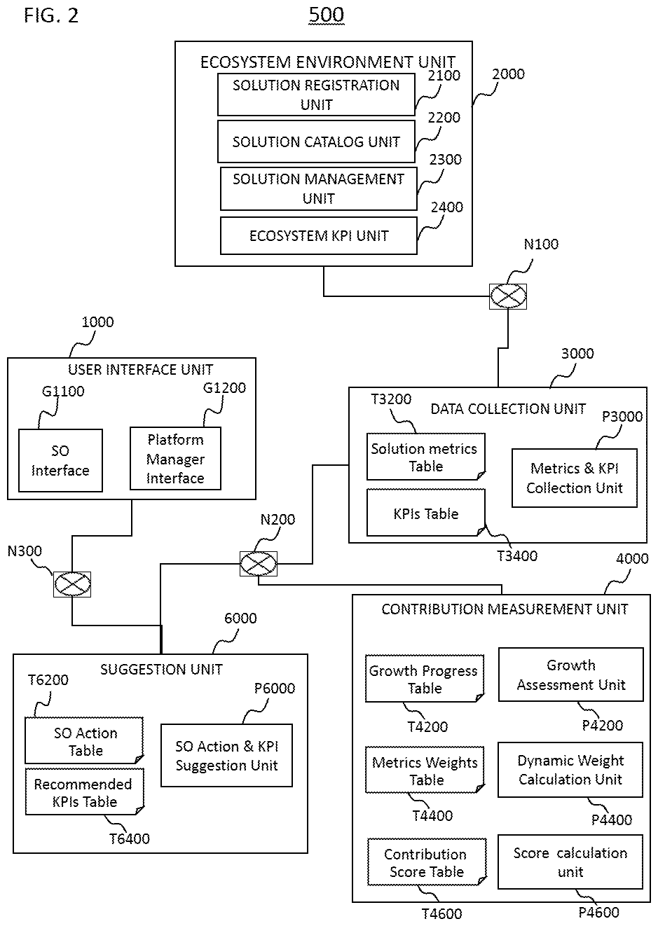

Next, an example configuration of a contribution management system according to embodiments of the present disclosure will be described with reference to FIG. 2.

FIG. 2 is a block diagram illustrating an example configuration of a contribution management system 500 according to embodiments of the present disclosure. As illustrated in FIG. 2, the contribution management system 500 includes a user interface unit 1000, an ecosystem environment unit 2000, a data collection unit 3000, a contribution measurement unit 4000, and a suggestion unit 6000. Here, each of the user interface unit 1000, ecosystem environment unit 2000, data collection unit 3000, contribution measurement unit 4000, and suggestion unit 6000 (hereinafter generally referred to as “functional units”) may be implemented as one or more software programs stored on a server device (e.g., the computer system 100 illustrated in FIG. 1) and configured to perform a particular function.

As illustrated in FIG. 2, the ecosystem environment unit 2000 may include a solution registration unit 2100, a solution catalog unit 2200, a solution management unit 2300, and an ecosystem KPI unit 2400. The ecosystem environment unit 2000 is communicably connected to the data collection unit 3000 through communication network connection N100.

The solution registration data 2100 is a functional unit configured to host and deploy the solutions created by the solution owner. The solution catalogue unit 2200 is a functional unit configured to process the information for each solution in the digital ecosystem. The solution management unit 2300 is a functional unit configured to monitor the activities and performance of the solutions in the digital ecosystem. The ecosystem KPI unit 2400 is a functional unit configured to store and process the KPIs defined by the platform manager.

The data collection unit 3000 may include a metrics and KPI collection unit P3000 configured to collect a set of solution performance metrics and a set of ecosystem KPIs from the ecosystem environment unit 2000. The set of solution performance metrics are stored in solution performance metrics table T3200, and the set of ecosystem KPIs are stored in KPIs table T3400. The data collection unit 3000 is communicably connected with the contribution measurement unit 4000 and the suggestion unit 4600 through communication network connection N200.

The contribution measurement unit 4000 is a functional unit configured to assess the growth of the digital ecosystem, calculate the set of metric weights based on the growth of the digital ecosystem, and calculate a contribution score for each solution owner. As illustrated in FIG. 2, the contribution measurement unit 4000 may include a growth assessment unit P4200, a dynamic weight calculation unit P4400, and a score calculation unit P4600.

The growth assessment unit P4200 is a functional unit configured to assess the current growth of the digital ecosystem, and generate a set of growth progress data. More particularly, growth assessment unit P4200 may compare the set of solution performance metrics and a set of target KPIs to calculate a growth deficit for each solution performance metric of the set of solution performance metrics that indicates a difference between a current growth state and a desired growth state, and generate the growth progress data by aggregating the growth deficit for each solution performance metric of the set of solution performance metrics. The set of growth progress data is stored in the growth progress table T4200.

The dynamic weight calculation unit P4400 is a functional unit configured to calculate the set of metric weights based on the set of growth progress data stored in the growth progress table T4200 and/or KPIs set by the platform manager. The set of metric weights for each solution performance metric of the set of solution performance metrics are stored in the metric weights table T4400.

The score calculation unit P4600 is a functional unit configured to calculate a contribution score for the solution owner as a weighted average of the set of solution performance metrics and the set of metric weights. The output of the contribution score for each solution owner is stored in the contribution score table T4600. The contribution measurement unit is communicably connected to the suggestion unit 6000 through communication network connection N300.

The suggestion unit 6000 includes a solution owner action and KPI suggestion unit P6000 that determines a set of recommended actions for the solution owner and a set of recommended KPIs for the platform manager based on the contribution score (e.g., and or the set of ecosystem KPIs, set of growth progress data). The recommended actions for the solution owner are stored in the solution owner action table T6200, and the recommended KPIs are stored in the recommended KPIs table T6400. The suggestion unit 6000 is communicably connected to the user interface unit 1000 through communication network connection N300, and to the data collection unit 3000 through communication network connection N200.

The user interface unit 1000 includes a solution owner interface G1100 and a platform manager interface G1200. The solution owner interface G1100 is a user interface used by the solution owner for solution development and management, and to access the set of recommended actions suggested by the suggestion unit 6000. The platform manager interface G1200 is an administrator interface used by the platform manager, and is configured to display the set of recommended KPIs to the platform manager and to receive a set of ecosystem KPIs from the platform manager.

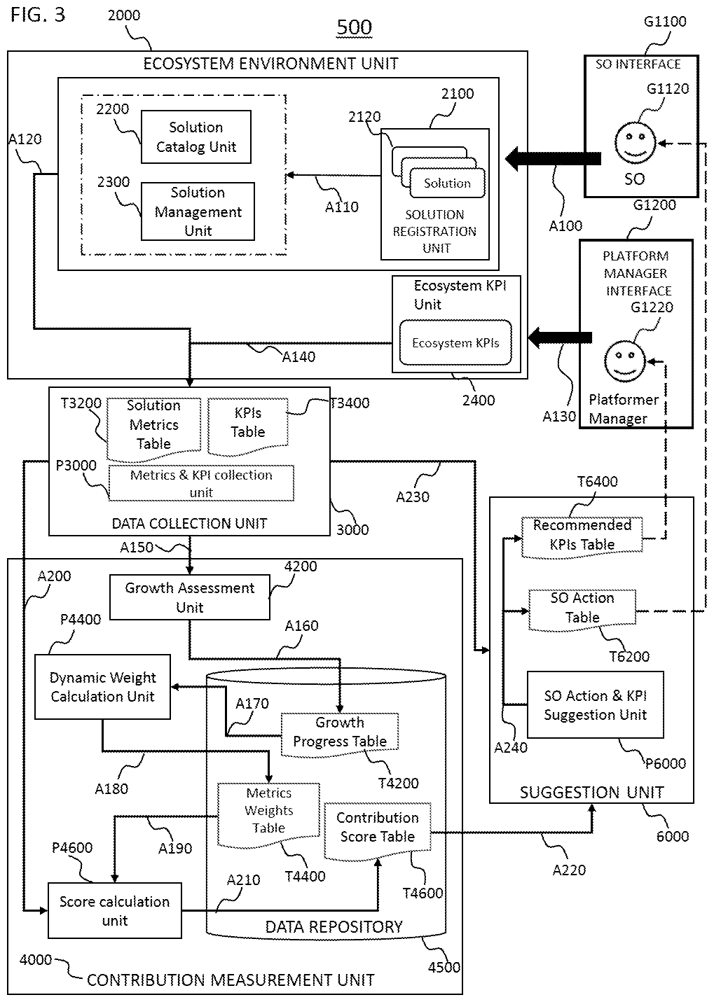

Next, the flow of data within the contribution management system 500 will be described with respect to FIG. 3.

FIG. 3 is a block diagram illustrating the flow of data within the contribution management system 500, according to embodiments of the present disclosure.

As described with reference to FIG. 2, the contribution management system 500 primarily includes a user interface unit having a solution owner interface G1100 and a platform manager interface G1200, an ecosystem environment unit 2000, a data collection unit 3000, a contribution measurement unit 4000, and a suggestion unit 6000.

The solution owner interface G1100 and the platform manager interface G1200 are graphical user interfaces for the solution owner and the platform manager, respectively. The ecosystem environment unit 2000 is a functional unit for receiving submission of a solution from a solution owner, and collecting information regarding the solutions in the digital ecosystem. The data collection unit 3000 is a functional unit for collecting solution performance metrics and ecosystem KPI data. The contribution measurement unit 4000 is a functional unit configured to assess the growth of the digital ecosystem based on the ecosystem KPIs and the set of solution performance metrics, calculate a set of metric weights based on the growth of the digital ecosystem, and calculate a contribution score for each solution owner. The suggestion unit 6000 is a functional unit configured to generate a set of recommended actions for the solution owner and a set of recommended KPIs for the platform manager.

Here, the term “solution owner” (abbreviated as “SO” in the Figures) refers to the party responsible for developing, maintaining, and improving digital solutions in the digital ecosystem. The term “platform manager” refers to the administrator or manager who is responsible for the management of the digital ecosystem. Additionally, the term “customer” refers to the party who uses the solution (e.g., in exchange for a fee, as a service).

Using the solution owner interface G1100, a solution owner G1120 may create new solutions, update existing solutions, monitor solutions, or perform other functions to manage solutions.

Using the platform manager interface G1200, a platform manager G1220 may monitor the status and activities performed within the digital ecosystem, and analyze the growth and progress of the digital ecosystem. Through the platform manager interface G1200, the platform manager G1220 may take necessary actions to control various factors to facilitate management of the digital ecosystem.

The ecosystem environment unit 2000 facilitates the registration, distribution, deployment, usage, monitoring, and management of solutions in the digital ecosystem. The solution registration unit 2100 may receive submission of one or more solutions 2120 from the solution interface G1100 via flow A100, and register the submitted solutions 2120 in the digital ecosystem. Additionally, the solution registration unit 2100 may facilitate deployment of the solutions 2120 to customers for use.

The solution catalog unit 2200 and the solution management unit 2300 are functional units configured to monitor the activity and performance of the solutions 2120 in the digital ecosystem. The solution catalog unit 2200 collects and stores metadata related to all the solutions 2120 present in the digital ecosystem. The solution management unit 2300 monitors and analyzes the performance of each solution 2120. The information collected by the solution catalog unit 2200 and the solution management unit 2300 are aggregated together as solution performance metrics.

The ecosystem KPI unit 2400 receives submission of a set of ecosystem KPIs and ecosystem target information from the platform manager interface G1200 through the flow A130. The ecosystem KPI unit stores and maintains all the past ecosystem KPIs, current ecosystem KPIs and ecosystem target information for the digital ecosystem. Here, KPIs refer to measurable values that demonstrate how effectively a particular objective is being achieved within the digital ecosystem, and may include the total number of solutions in the ecosystem, the profits earned by the solutions in the ecosystem, or the like.

The metrics and KPI collection unit P3000 of the data collection unit 3000 collects the solution performance metrics from the solution catalog unit 2200 and the solution management unit 2300 via flow A120, and collects the set of ecosystem KPIs from the ecosystem KPI unit 2400 via flow A140. Subsequently, the metrics and KPI collection unit P3000 stores the collected set of solution performance metrics in the solution performance metrics table T3200, and stores the collected set of ecosystem KPIs in the KPIs Table T3400. As will be described in detail later, the set of solution performance metrics table T3200 includes information regarding the profit earned by each solution 2120, the number of times a particular solution 2120 was used, and other solution performance metrics for each solution 2120. Additionally, the KPIs table T3400 includes ecosystem target information, such as the expected profit earned by the solutions 2120, the expected number of solutions 2120, and other goals within the digital ecosystem.

The contribution measurement unit 4000 is a functional unit for analyzing the growth of the digital ecosystem, generating growth progress data, and calculating a contribution score for each solution owner G1120. A set of metric weights are calculated using a dynamic weight calculation method, and are analyzed in order to provide a set of recommended actions to the solution owner G1120 and a set of recommended KPIs to the platform manager G1220.

The contribution score for the solution owner G1120 is calculated as a weighted average of the set of solution performance metric values and the set of metric weights. In embodiments, aspects of the disclosure relate to the recognition that the digital ecosystem may have different requirements (e.g., business goals, targets) based on its current growth stage. Here, the term “growth” refers to the maturity of the digital ecosystem, and is defined in terms of the number of solutions, number of contributing solution owners, profit earned by solutions, and other criteria. That is, digital ecosystems with larger numbers of solutions, contributing solution owners, and profit may be considered to be in a later growth stage (e.g., more mature) than digital ecosystems with smaller numbers of solutions, contributing solution owners, or profit.

For instance, a digital ecosystem in a primitive growth stage may have different KPIs and ecosystem targets when compared to a digital ecosystem in a more mature growth stage. Accordingly, aspects of the present disclosure relate to assessing the current stage of growth of the digital ecosystem, and calculating the contribution score in accordance with this current stage of growth.

The growth assessment unit 4200 is configured to assess the current growth of the ecosystem and compare it with the set of ecosystem KPIs set by the platform manager G1220 to generate a set of growth progress data. Based on this growth progress data, the dynamic weight calculation unit 4400 calculates the set of metric weights. This set of metric weights is used to calculate the contribution score.

More particularly, first, the growth assessment unit 4200 collects the set of solution performance metrics from the solution performance metrics table T3200 and the ecosystem KPIs from the KPIs table T3400 through flow A150. The growth assessment unit 4200 uses the set of solution performance metrics and the set of ecosystem KPIs to analyze the growth of the digital ecosystem, and generate a set of growth progress data indicating the current growth state of the digital ecosystem. The growth assessment unit 4200 stores this set of growth progress data in the growth progress table T4200 through flow A160. As will be described later, this growth progress table T4200 includes information related to the current state of the digital ecosystem, the required state of the digital ecosystem, and the deficit between the current state and the required state for each solution performance metric. Here, the term “deficit” refers to the difference between the current growth state of the digital ecosystem as indicated by the solution performance metrics and the desired/required growth state of the digital ecosystem as indicated by the set of ecosystem KPIs.

The dynamic weight calculation unit P4400 obtains the growth progress data from the growth progress table T4200 through flow A170. The dynamic weight calculation unit P4400 is configured to analyze the growth progress data from the growth progress table T4200 and calculate the set of metric weights accordingly. For example, if the growth progress table T4200 indicates that there is a deficit in a solution performance metric of “total number of solutions in the digital ecosystem,” then the dynamic weight calculation unit P4400 may calculate a higher value of the metric weight corresponding to this solution performance metric to indicate that greater importance should be placed on the number of solutions contributed by the solution owner G1120 when calculating the contribution score. In this way, a metric weight is calculated for each solution performance metric based on the growth progress data in the growth progress table T4200. The set of metric weights is stored in the metric weights table T4400 through flow A180.

The score calculation unit P4600 obtains the solution performance metric values from the solution performance metrics table T3200 via flow A200 and obtains the set of metric weights from the metric weight table T4460 via flow A190, and subsequently calculates the contribution score for each solution owner G1120 as a weighted average of the solution performance metric values from the solution performance metrics table T3200 and the set of metric weights from the metric weight table T4460. The score calculation unit P4600 stores the contribution score calculated for each solution owner in the contribution score table T4600 through flow A210.

The suggestion unit 6000 is configured to generate and provide a set of recommended actions to the solution owner G1120 and a set of recommended KPIs to the platform manager G1220 based on the contribution score. As illustrated in FIG. 3, the suggestion unit 6000 includes a solution owner action and KPI suggestion unit P6000 configured to obtain the contribution score for each solution owner G1120 from the contribution score table T4600 via flow A220, and subsequently analyze the contribution scores to generate a set of recommended actions for the solution owner G1120 that can further facilitate growth of the digital ecosystem and result in a higher contribution score. The solution owner action and KPI suggestion unit P6000 stores this set of recommended actions in the solution owner action table T6200 through flow A240. The set of recommended actions may be provided to the solution owner G1120 through the SO interface G1100.

Additionally, the solution owner action and KPI suggestion unit P6000 may be configured to generate a set of recommended KPIs based on the contribution score, the ecosystem KPIs, and the set of growth progress data (e.g., an ecosystem growth trend obtained by analyzing the past and current growth of the ecosystem as indicated by the set of growth progress data). This set of recommended KPIs is stored in the recommended KPIs table T6400, and is recommended to the platform manager G1220 through the platform manager interface G1200.

As described above, by means of the contribution management system 500 configured as described in FIG. 2 and FIG. 3, it is possible to quantify the contribution of solution owners to digital ecosystems in consideration of the growth progress of the digital ecosystem, and generate recommended actions that directly facilitate the continued growth of the digital ecosystem as a whole.

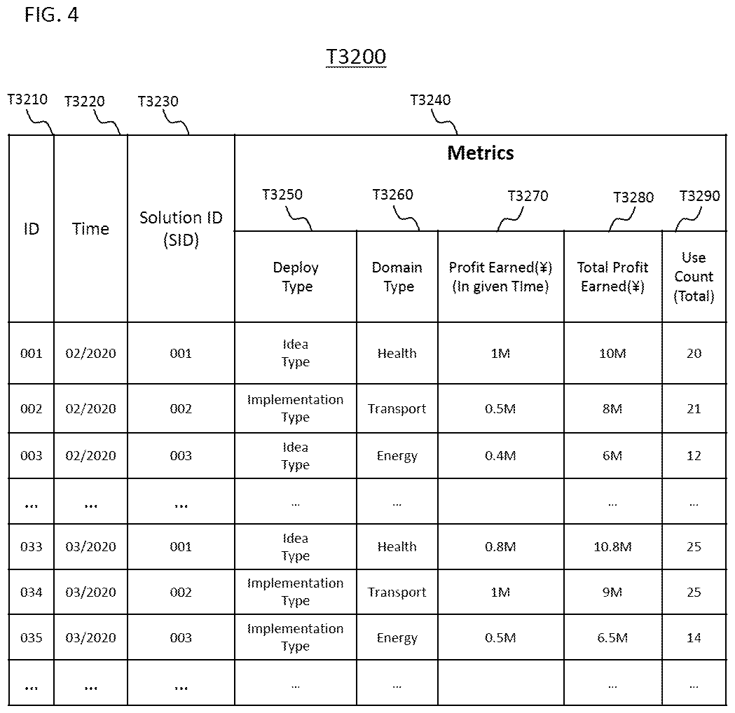

Next, example configurations of the various tables used in the embodiments of the present disclosure will be described with reference to FIG. 4 to FIG. 10. It should be noted that the tables illustrated in the following figures are merely examples, and the contents of the table are in no way limited to the information shown herein. As such, the various tables may be adapted to store information in accordance with the specific digital ecosystem to which the aspects of the present disclosure are applied.

FIG. 4 illustrates an example configuration of a solution performance metrics table T3200 according to embodiments of the present disclosure. As described herein, the solution performance metrics table T3200 includes information regarding the various solution performance metrics used to define the performance of a solution in the digital ecosystem, and may include a solution metric ID T3210, a time T3220, a solution ID T3230, and various solution performance metrics T3240.

The solution metric ID T3210 specifies an identifier for uniquely defining each entry in the solution performance metrics table T3200. The time T3220 represents the time at which the solution performance metric values were recorded or collected. The solution ID T3230 specifies an identifier that uniquely identifies the solution from which the solution performance metrics were collected.

The solution performance metrics T3240 are the solution performance metrics collected for various solutions (e.g., collected by the metrics and KPI collection unit P3000 illustrated in FIG. 2 and FIG. 3). As examples, in embodiments, the solution performance metrics T3240 may include a deploy type T3250, a domain type T3260, profit earned in a given time T3270, total profit earned T3280, and a total use count T3290.

The deploy type T3250 indicates the type of the deployment of the solution (e.g., an idea type that proposes a theoretical solution, an implementation type that provides a particular software or service). The domain type T3260 indicates the domain to which the solution belongs (e.g., health, transport, energy). The profit earned in a given time T3270 indicates the profit earned by the solution in a particular time period. The total profit earned T3280 indicates the total profit earned by the solution for all time periods. The total use count T3290 indicates the total number of times the solution has been used by customers.

As described herein, the solution performance metrics stored in the solution performance metrics table T3200 can be used together with the ecosystem KPIs to assess the growth state of the digital ecosystem.

Additionally, it should be noted that the solution performance metrics table T3200 illustrated in FIG. 4 is merely an example, and other information other than that illustrated in FIG. 4 may be maintained in the solution performance metrics table T3200.

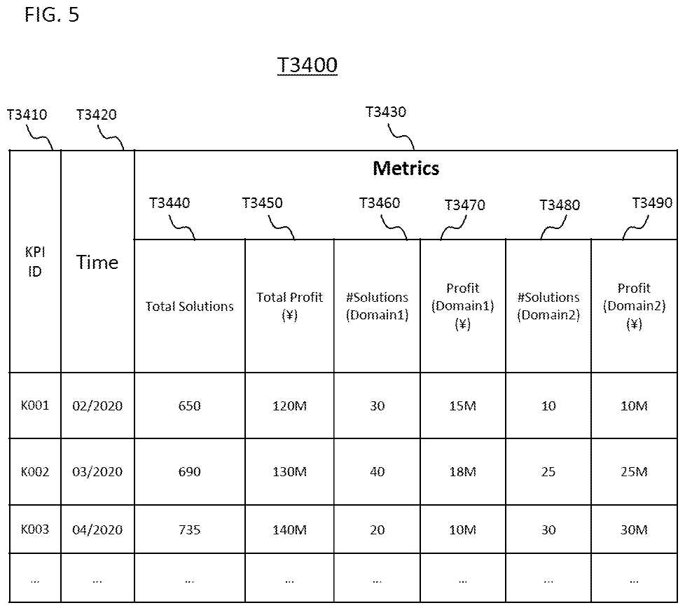

Next, an example configuration of a KPIs table according to embodiments of the present disclosure will be described with reference to FIG. 5.

FIG. 5 illustrates an example configuration of a KPIs table T3400 according to embodiments of the present disclosure. As described herein, the KPIs table T3400 includes the set of ecosystem KPIs set for the digital ecosystem by the platform manager for a particular time period (e.g., collected by the metrics and KPI collection unit P3000 illustrated in FIG. 2 and FIG. 3) and may include a KPI ID T3410, a time 3420, and a set of metrics T3430.

The KPI ID T3410 specifies an identifier for uniquely defining each entry in the KPIs table T3400. The time 3420 represents the time at which the ecosystem KPI was recorded or collected. The total solutions T3440 indicates the count of the total number of solutions in the digital ecosystem. The total profit T3450 indicates the total profit earned by all the solutions in the digital ecosystem. #Solutions (Domain 1) T3460 indicates the total number of solutions in the digital ecosystem that are related to a first domain, Domain 1. Profit (Domain 1) T3470 indicates the profit earned by the solutions corresponding to Domain 1. #Solutions (Domain2) T3480 indicates the total number of solutions in the digital ecosystem that are related to a second domain, Domain 2. Profit (Domain2) T3490 indicates the profit earned by the solutions corresponding to Domain 2.

As described herein, the ecosystem KPIs stored in the KPIs table T3400 can be used together with the solution performance metrics to assess the growth state of the digital ecosystem.

Additionally, it should be noted that the KPIs table T3400 illustrated in FIG. 5 is merely an example, and other information other than that illustrated in FIG. 5 may be maintained in the KPIs table T3400.

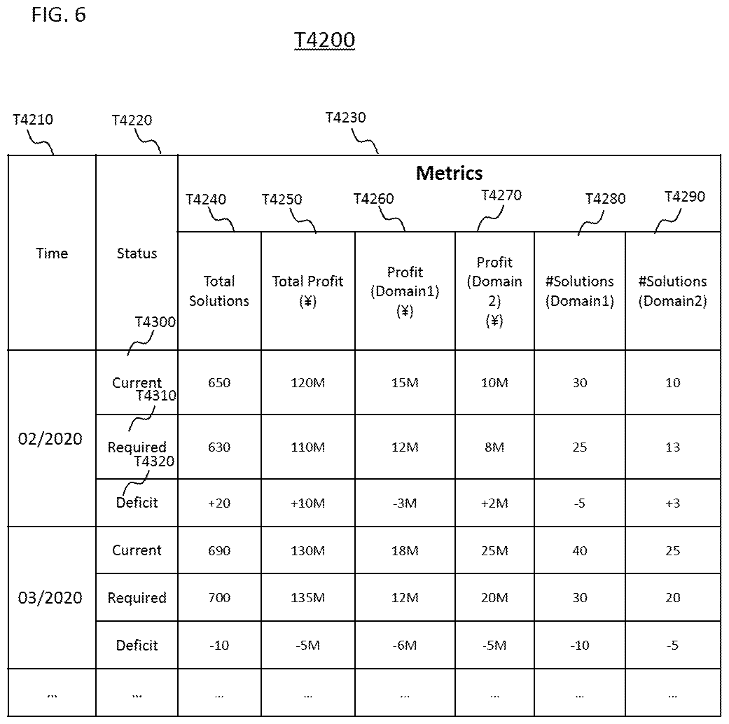

Next, an example configuration of a growth progress table according to embodiments of the present disclosure will be described with reference to FIG. 6.

FIG. 6 illustrates an example configuration of a growth progress table T4200 according to embodiments of the present disclosure. As described herein, the growth progress table T4200 includes information defining the difference between a current growth state and a desired growth state for a variety of solution performance metrics. The growth progress table T4200 is generated by the growth assessment unit 4200 through flow A160 based on an assessment of the solution performance metrics table and the KPIs table.

As illustrated in FIG. 6, the growth progress table T4200 includes a time T4210, a status T4220, and metrics T4230. The time 4210 represents the time at which the growth progress data was collected or generated. The status T4220 illustrates a status of “Current” T4300, “Required” T4310, and “Deficit” T4320 for each metric.

Current T4300 indicates the current state of each metric. Required T4310 indicates the necessary state of each metric (e.g., the goal or target defined by the platform manager). Deficit T4320 indicates the difference between Current T4300 and Required T4320. Here, the Deficit T4320 may be a negative value, indicating that the Current T4300 falls short of the Required T4320, 0, indicating that the Current T4300 achieves the Required T4320, or a positive value, indicating that the Current T4300 exceeds the Required T4320.

The metrics T4230 include total solutions T4240, Total profit T4250, profit (Domain1) T4260, profit (Domain2) T4270, #Solutions (Domain1) T4280, and #Solutions (Domain 2) T4290. The total solutions T4240 indicates the count of the total number of solutions in the digital ecosystem. The total profit T4250 indicates the total profit earned by all the solutions in the digital ecosystem. Profit (Domain1) T4260 indicates the profit earned by the solutions corresponding to Domain 1. Profit (Domain2) T4270 indicates the profit earned by the solutions corresponding to Domain 2. #Solutions (Domain1) T4280 indicates the total number of solutions in the digital ecosystem that are related to Domain 1. #Solutions (Domain2) T4290 indicates the total number of solutions in the digital ecosystem that are related to Domain 2.

The growth progress table T4200 provides insights related to the growth state of the digital ecosystem. As an example, metrics for which the Deficit T4320 is a negative value indicate areas for which additional growth is desirable, whereas metrics for which the Deficit T4320 is a positive value indicate areas for which growth exceeded expectations. As described herein, based on the growth progress data stored in the growth progress table T4200, a set of metric weights can be calculated to facilitate calculation of a contribution score for the solution owners that reflects the growth state of the digital ecosystem.

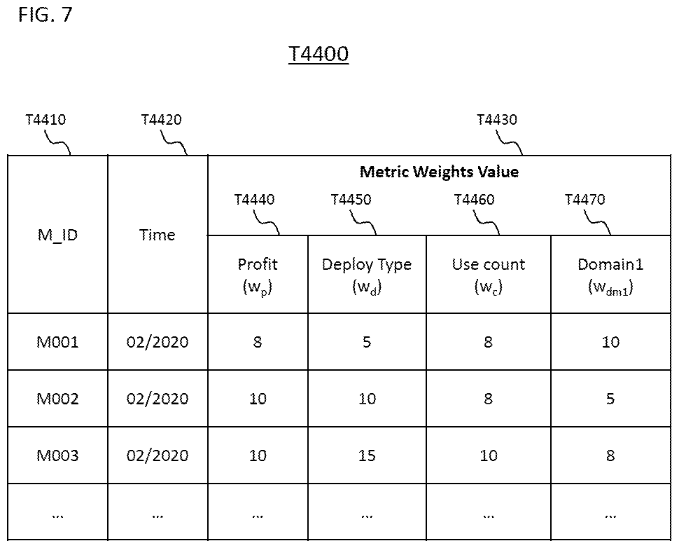

Next, an example configuration of a metric weights table according to embodiments of the present disclosure will be described with reference to FIG. 7.

FIG. 7 illustrates an example configuration of a metric weights table T4400 according to embodiments of the present disclosure. As described herein, the metrics weight table T4400 includes information regarding the set of metric weights adapted based on the growth progress data of the growth progress table. The metrics weight table T4400 is generated by the dynamic weight calculation unit P4400 through flow A180.

As illustrated in FIG. 7, the metric weights table T4400 includes a Metric ID T4410, a time T4420, and metric weights values T4430. The Metric ID (abbreviated as M_ID in FIG. 7) specifies an identifier for uniquely defining each entry in the metric weights table T4400. The time T4420 represents the time at which the metric weight value was generated. Here, the metric weights values T4430 specify the metric weights values T4430 that have been calculated based on the growth progress data in the growth progress table for a variety of solution performance metrics.

For instance, the metric weights values T4430 may include weight values for metrics of profit T440, deploy type T4450, use count T4460, and Domain1 T4470. In embodiments, the metrics weights values T4430 may be represented as values between 0 and 10, where lower values indicate lower degrees of relative importance, and larger values indicate greater degrees of relative importance.

As described herein, the metric weights values T4430 that have been calculated based on the growth progress data in the growth progress table can be used to facilitate the calculation of a contribution score for the solution owners that reflects the growth state of the digital ecosystem.

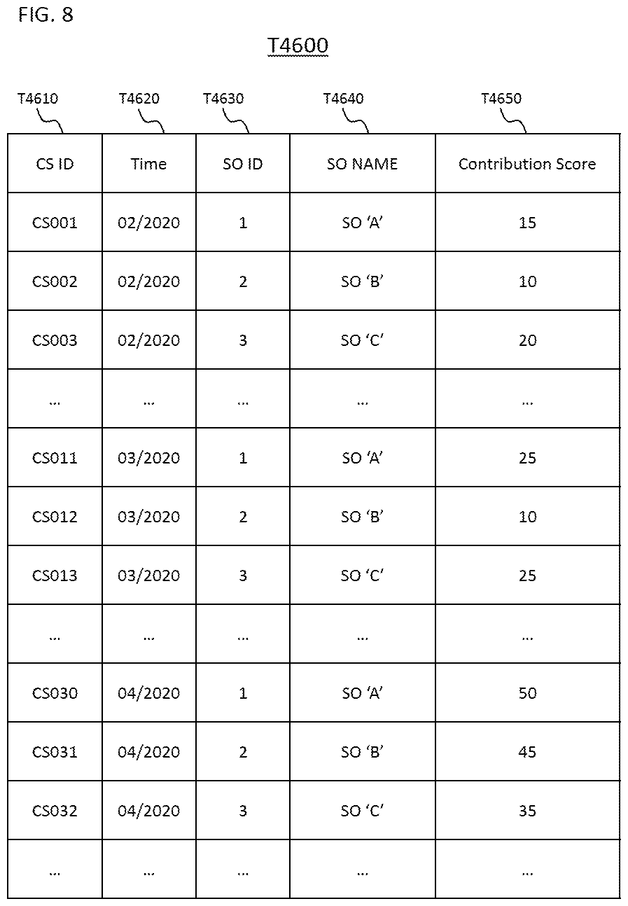

Next, an example configuration of a contribution score table according to embodiments of the present invention will be described with reference to FIG. 8.

FIG. 8 illustrates an example configuration of a contribution score table T4600 according to embodiments of the present invention. As described herein, the contribution score table T4600 includes information indicating the contribution score for each solution owner in the digital ecosystem. The contribution score table T4600 is generated by the score calculation unit P4600 through flow A210.

As illustrated in FIG. 8, the contribution score table T4600 includes a contribution score ID T4610 (abbreviated as CS ID in FIG. 8), a time T4620, a solution owner ID T4630, a solution owner name T4640, and a contribution score T4650.

The contribution score ID T4610 specifies an identifier for uniquely defining each entry in the contribution score table T4600. The time T4630 represents the time at which the contribution score was calculated. The solution owner ID T4630 specifies an identifier for uniquely defining each solution owner in the digital ecosystem. The solution owner name T4640 indicates the name of the solution owner. The contribution score T4650 indicates the contribution score calculated for the solution owner. The contribution score T4650 may be calculated based on the set of solution performance metrics (e.g., the set of solution performance metrics stored in the solution performance metric table T3200 illustrated in FIG. 4) and the set of metric weights that have been adapted based on the growth progress data of the digital ecosystem (e.g., the set of metric weights stored in the metric weights table T4400 illustrated in FIG. 7).

As described herein, the contribution score T4650 is a quantitative indication of the degree to which a solution owner has contributed to the growth of the digital ecosystem. The contribution score may be represented as a value between 0 and 100, where smaller values indicate lesser degrees of contribution and larger values indicate greater degrees of contribution.

As described herein, the contribution scores T4650 may be used to generate a set of recommended actions for the solution owner and a set of recommended KPIs for the platform owner in order to further facilitate growth of the digital ecosystem.

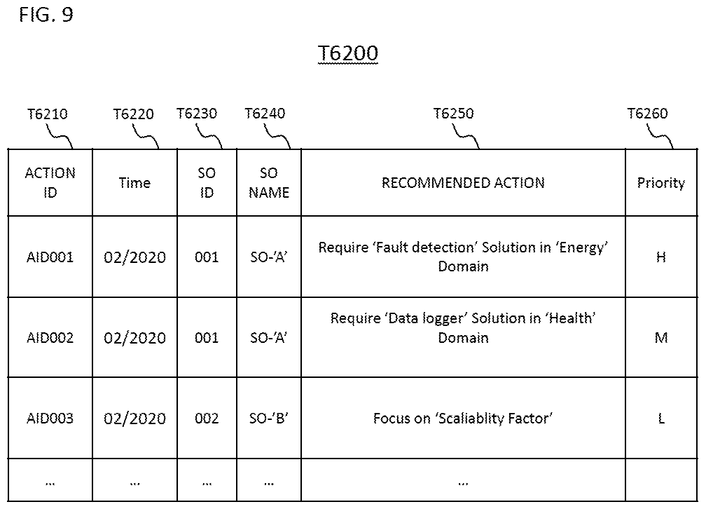

Next, an example configuration of a solution owner action table according to embodiments of the present disclosure will be described with reference to FIG. 9.

FIG. 9 illustrates an example configuration of a solution owner action table T6200 according to embodiments of the present disclosure. As described herein, the solution owner action table T6200 includes information indicating the set of recommended actions for the solution owner to increase their contribution score and facilitate continued growth of the digital ecosystem. The solution owner action table T6200 is generated by the solution owner action and KPI suggestion unit P6000 based on the contribution score through flow A240.

As illustrated in FIG. 9, the solution owner action table T6200 includes an action ID T6210, a time T6220, a solution owner ID T6230, a solution owner name T6240, a recommended action T6250, and a priority T6260.

The action ID T6210 specifies an identifier for uniquely defining each entry in the solution owner action table T6200. The time T6220 represents the time at which the recommended action was generated. The solution owner ID T6230 specifies an identifier for uniquely defining each solution owner in the digital ecosystem. The solution owner name T6240 indicates the name of the solution owner. The recommended action T6250 indicates the recommended action for the solution owner to increase his or her contribution score and contribute to the continued growth of the digital ecosystem. The priority T6260 indicates the priority (e.g., High, medium, or low) of the recommended action T6250.

As examples, as illustrated in FIG. 9, the solution owner action table T6200 may indicate recommended actions T6250 of “require ‘fault detection’ solution in ‘energy’ domain” “require ‘data logger’ solution in ‘health’ domain,” or “focus on ‘scalability factor.’”

As described herein, by performing the recommended action T6250 suggested in the solution owner action table T6200, a solution owner may increase his or her contribution score and facilitate continued growth of the digital ecosystem. Further, in certain embodiments, solution owners may be provided with incentives based on their contribution score. As an example, solution owners having greater contribution scores may receive greater financial compensation (e.g., greater portion of profits) for their solutions. Other types of incentives based on the contribution score are also possible.

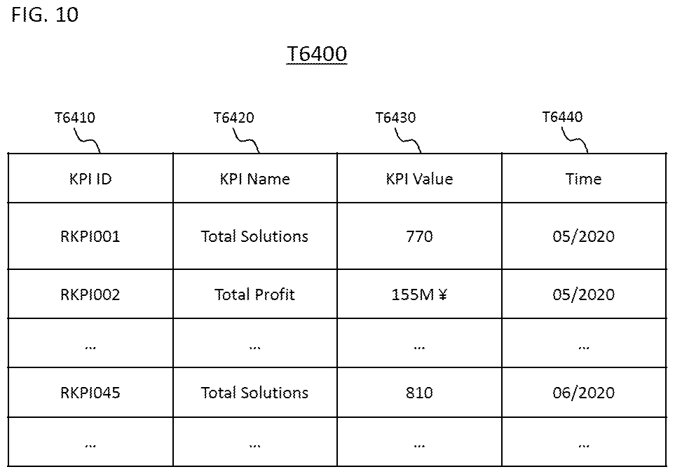

Next, an example configuration of a recommended KPIs table according to the embodiments of the present disclosure will be described with reference to FIG. 10.

FIG. 10 illustrates an example configuration of a recommended KPIs table T6400 according to the embodiments of the present disclosure. As described herein, the recommended KPIs table T6400 includes information indicating the set of recommended KPIs for the platform manager. The recommended KPIs may be KPIs recommended by the contribution management system to facilitate continued growth of the digital ecosystem. The recommended KPIs table T6400 is generated by the solution owner action and KPI suggestion unit P6000 based on the contribution score (e.g., the contribution score stored in the contribution score table T4600 illustrated in FIG. 8), the set of ecosystem KPIs (e.g., the set of ecosystem KPIs stored in the KPIs table T3400 illustrated in FIG. 5), and the set of growth progress data (e.g., the set of growth progress data stored in the growth progress table T4200 illustrated in FIG. 6) through flow A240.

As illustrated in FIG. 10, the recommended KPIs table T6400 includes a KPI ID T6410, a KPI name T6420, a KPI value T6430, and a time T6440.

The KPI ID T6410 specifies an identifier for uniquely defining each entry in the recommended KPIs table T6400. The KPI name T6420 specifies the name of the KPI. The KPI value T6430 specifies that value designated by the KPI. The time T6440 represents the time when the KPI was generated.

As described herein, platform owners may reference the recommended KPIs stored in the recommended KPIs table T6400, and set new KPIs for the digital ecosystem based on the recommended KPIs table T6400 in order to facilitate continued growth of the digital ecosystem.

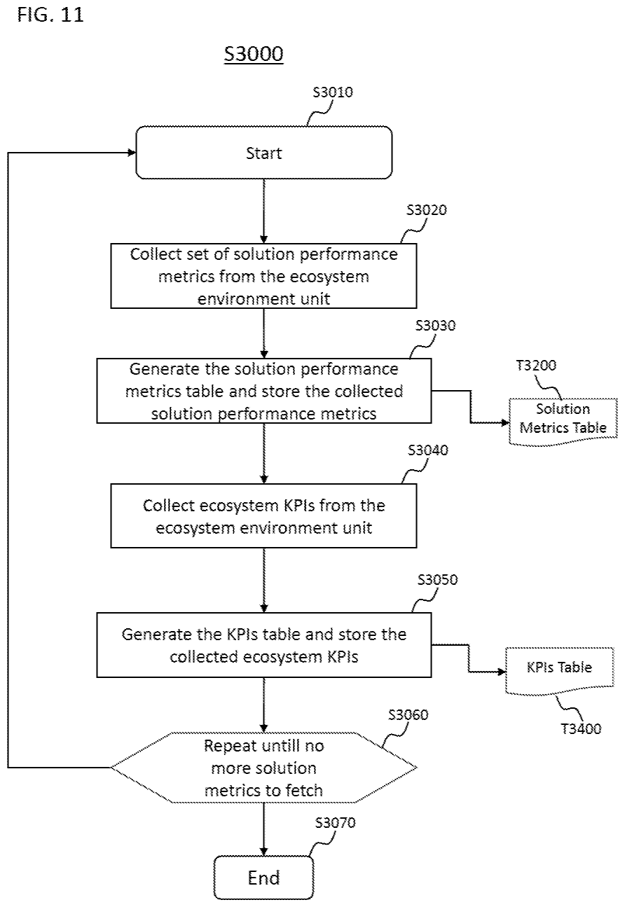

Next, the flow of a metrics and KPI collection process performed by the metrics and KPI collection unit according to the embodiments of the present disclosure will be described with reference to FIG. 11.

FIG. 11 is a flowchart illustrating the flow of a metrics and KPI collection process S3000 performed by the metrics and KPI collection unit P3000 according to the embodiments of the present disclosure. The metrics and KPI collection process S3000 is a process for collecting the set of solution performance metrics and the set of ecosystem KPIs. As illustrated in FIG. 11, the metrics and KPI collection process S3000 starts at Step S3010 and ends at Step S3070.

First, at Step S3020, the metrics and KPI collection unit P3000 collects the set of solution performance metrics from the ecosystem environment unit (e.g., the ecosystem environment unit 2000 illustrated in FIG. 2 and FIG. 3). More particularly, the metrics and KPI collection unit P3000 may collect the set of solution performance metrics from the solution catalog unit 2200 and the solution management unit 2300 of the ecosystem environment unit 2000.

Next, at Step S3030, the metrics and KPI collection unit P3000 generates the solution performance metrics table T3200, and stores the set of solution performance metrics collected in Step S3020 in the solution performance metrics table T3200.

Next, at Step S3040, the metrics and KPI collection unit P3000 collects the ecosystem KPIs from the ecosystem environment unit 2000. More particularly, the metrics and KPI collection unit P3000 may collect the set of ecosystem KPIs input to the ecosystem KPI unit 2400 by the platform manager using the platform manager interface.

Next, at Step S3050, the metrics and KPI collection unit P3000 generates the KPIs table T3400, and stores the set of ecosystem KPIs collected in Step S3040 in the KPIs table T3400.

Next, at Step S3060, the metrics and KPI collection unit P3000 checks the ecosystem environment unit 2000 to determine if there are other solution performance metrics or ecosystem KPIs to be collected. In the case that there are additional solution performance metrics or ecosystem KPIs to be collected, the metrics and KPI collection process S3000 returns to Step S3010 and repeats the following steps. This process is repeated until there are no more solution performance metrics or ecosystem KPIs to be collected. In the case that there are no additional solution performance metrics or ecosystem KPIs to be collected, the metrics and KPI collection process S3000 ends at Step S3070.

By means of the metrics and KPI collection process S3000, the set of solution performance metrics and the set of ecosystem KPIs can be collected and stored. As described herein, set of solution performance metrics and the set of ecosystem KPIs collected here can be used to assess the growth of the digital ecosystem, and calculate contribution scores for the solution owners contributing to the digital ecosystem.

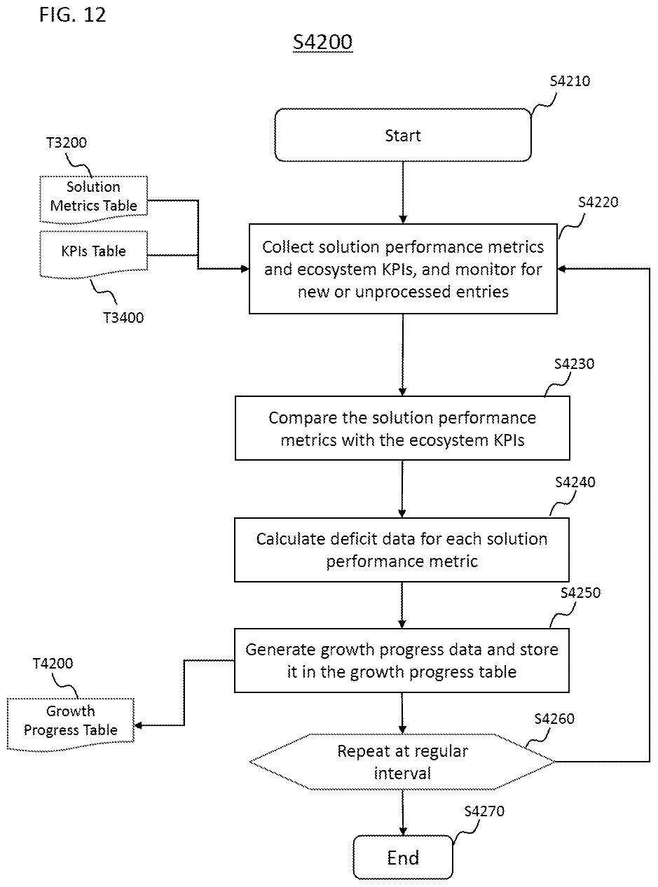

Next, the flow of a growth assessment process performed by the growth assessment unit according to the embodiments of the present disclosure will be described with reference to FIG. 12.

FIG. 12 is a flowchart illustrating the flow of a growth assessment process S4200 performed by the growth assessment unit P4200 according to the embodiments of the present disclosure. The growth assessment process S4200 is a process for assessing the growth state of the digital ecosystem based on the set of solution performance metrics and the set of ecosystem KPIs. As illustrated in FIG. 12, the growth assessment process S4200 starts at Step S4210 and ends at Step S4270.

First, at Step S4210, the growth assessment unit P4200 collects the set of solution performance metrics from the solution performance metrics table T3200 and collects the set of ecosystem KPIs from the KPIs table T3400. Additionally, the growth assessment unit P4200 may monitor for entries that are newly added to the solution performance metrics table T3200 or the KPIs table T3400, as well as keep track of those entries that have not yet been processed by the growth assessment unit P4200. As described herein, the set of solution performance metrics include information that characterizes the performance and usage of the solutions in the digital ecosystem. The set of ecosystem KPIs include information that represents the desired operational targets of the digital ecosystem (e.g., profit goals, number of solutions, or the like).

Next, at Step S4230, the growth assessment unit P4200 compares the set of solution performance metrics with the set of ecosystem KPIs in order to assess the current growth state of the digital ecosystem and the desired growth state of the digital ecosystem. As described herein, as the set of solution performance metrics indicate the current growth state of the digital ecosystem in terms of the performance and usage of the solutions, and the set of ecosystem KPIs indicate the desired growth state of the digital ecosystem, comparing the set of solution performance metrics with the set of ecosystem KPIs can yield insights into the difference between the current growth state and the desired growth state.

Next, at Step S4240, the growth assessment unit P4200 calculates deficit data for each solution performance metric of the set of solution performance metrics. As described herein, this deficit data refers to the difference between the current growth state of the digital ecosystem as indicated by the solution performance metrics and the desired/required growth state of the digital ecosystem as indicated by the ecosystem KPIs. In embodiments, the deficit for each solution performance metric may be calculated using the following equation.

Deficit=Current−Required [Equation 1]

Here, “current” refers to the current state of the digital ecosystem (e.g., the current state indicated by Current T4300 in the Growth Progress Table T4200 illustrated in FIG. 6), “required” refers to the desired state of the digital ecosystem (e.g., the required state indicated by Required T4310 in the Growth Progress Table T4200 illustrated in FIG. 6), and “deficit” refers to the difference between the current state and the desired state of the digital ecosystem (e.g., the deficit indicated by Deficit T4320 in the Growth Progress Table T4200 illustrated in FIG. 6). Here, the deficit may be a negative value, indicating that the current growth state falls short of the required growth state, 0, indicating that the current growth state achieves the required growth state, or a positive value, indicating that the current growth state exceeds the required growth state.

Next, at Step S4250, the growth assessment unit P4200 generates the growth progress table T4200. Here, the growth assessment unit P4200 may aggregate the current growth state indicated by the set of solution performance metrics, the required growth state indicated by the set of ecosystem KPIs, and the deficit data calculated in Step S4240 for each solution performance metric in order to generate the growth progress table T4200

Next, at Step S4260, the growth assessment unit P4200 may return to Step S4220, and the growth assessment process S4200 may be repeated at regular intervals for additional sets of solution performance metrics and ecosystem KPIs. In embodiments, the growth assessment process S4200 may be repeatedly performed at a regularly scheduled time interval (e.g., 1 hour, 6 hours, 12 hours, 1 day, 3 days, 1 week), when a particular amount of unprocessed solution performance metrics and ecosystem KPIs have accumulated (e.g., 10 unprocessed entries, 30 unprocessed entries), or in real time when a new solution performance metric or ecosystem KPI is detected.

By means of the growth assessment process S4200, the growth state of the digital ecosystem may be assessed based on the collected set of solution performance metrics and set of ecosystem KPIs. Accordingly, as described herein, based on the growth progress data obtained from this growth assessment, the set of metric weights for the set of solution performance metrics can be adapted to facilitate calculation of a contribution score for the solution owners that reflects the growth state of the digital ecosystem.

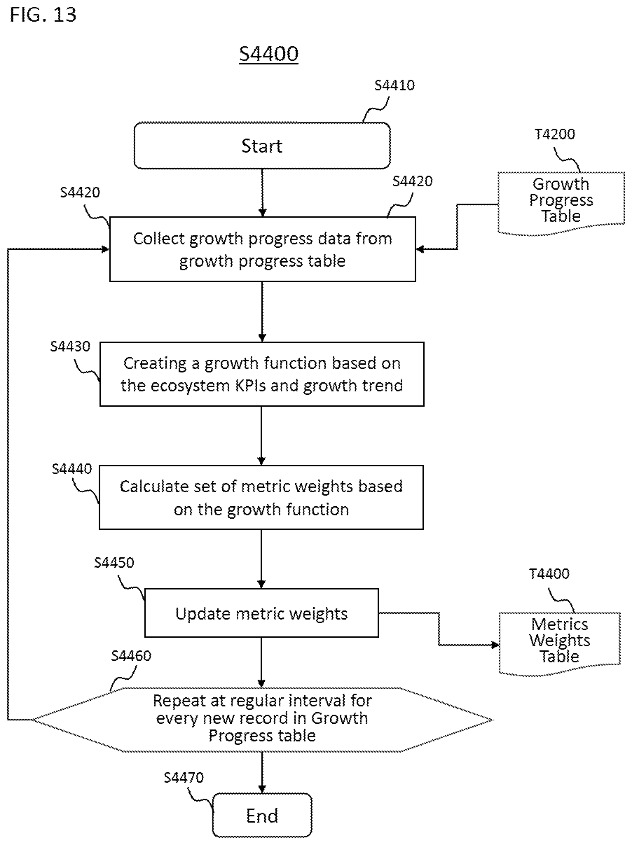

Next, the flow of a dynamic weight calculation process performed by the dynamic weight calculation unit according to embodiments of the present disclosure will be described with reference to FIG. 13.

FIG. 13 is a flowchart illustrating the flow of a dynamic weight calculation process S4400 performed by the dynamic weight calculation unit P4400 according to embodiments of the present disclosure. The dynamic weight calculation process S4400 is a process for calculating the set of metric weights based on growth progress data illustrating the growth state of the digital ecosystem. As illustrated in FIG. 13, the dynamic weight calculation process S4400 starts at Step S4410 and ends at Step S4470.

First, at Step S4420, the dynamic weight calculation unit P4400 collects the growth progress data from the growth progress table T4200. As described herein, the growth progress data includes information related to the current state of the digital ecosystem, the required state of the digital ecosystem, and the deficit between the current state and the required state for each solution performance metric. In embodiments, collecting the growth progress data may include fetching new or unprocessed entries from the growth progress table T4200.

Next, at Step S4430, the dynamic weight calculation unit P4400 creates a growth function based on the set of growth progress data collected in Step S4420. More particularly, the dynamic weight calculation unit P4400 may analyze the set of growth progress data to ascertain a growth trend of the digital ecosystem, and use this growth trend together with the set of ecosystem KPIs to create the growth function. Here, the growth trend may include a quantitative indication of the rate of growth (e.g., in terms of profit, number of solutions, or other characteristic) of the digital ecosystem, and be determined based on the set of growth progress data for one or more time periods (e.g., a current time period and a past time period). Additionally, the growth function may be a mathematical function that can be used to model the rate of growth of the digital ecosystem with respect to one or more solution performance metrics. As an example, the growth function may be represented as a function of profit, deploy-type, use count, or other solution performance metric (that is, F(profit, deploy-type, use-count . . . )).

Here, the growth function is a function of the set of solution performance metrics (profit, deploy-type, use-count). Changes in the values of the ecosystem KPIs result in changes in the growth function. As an example, the change in the growth function with respect to a solution performance metric of “profit” may be calculated according to the following Equation 2.

$$\frac{\partial F}{\partial ( profit )} \qquad [ Equation 2 ]$$

The change in the growth function is calculated with respect to each solution metric. For example, the change in the growth function with respect to solution performance metrics of “deploy-type” and “use-count” may be calculated according to the following Equation 3.

$$\frac{\partial F}{\partial deploy - type} , \frac{\partial F}{\partial use - count} \qquad [ Equation 3 ]$$

Next, at Step S4440, the set of metric weights are calculated using the growth function. More particularly, a new metric weight W_{m(new)} that takes into account the growth of the digital ecosystem can be adapted from an old metric weight W_{m(old)} according to the following Equation 4. Here, “adapting” refers to modifying, scaling, revising, or otherwise adjusting the original set of metric weights based on the growth of the digital ecosystem in order to generate a new set of adapted metric weights.

$${W}_{m ( new )} = {W}_{m ( old )} + \frac{\partial F}{\partial m} \qquad [ Equation 4 ]$$

Here, W_{m(new)} is a newly calculated (e.g., adapted) metric weight for a particular metric m, W_{m(old)} is the metric weight for the particular metric m prior to being adapted, and δF/δm represents the rate of change for the metric m. In this way, the metric weights for each solution performance metric can be adapted to new metric weights in consideration of the growth of the digital ecosystem.

Next, at Step S4450, the dynamic weight calculation unit P4400 updates the metric weights table T4400 with the adapted set of metric weights calculated in Step S4440. More particularly, the dynamic weight calculation unit P4400 may generate the metric weights table T4400 and store the adapted set of metric weights in the metric weights table T4400.

Next, at Step S4460, the dynamic weight calculation unit P4400 checks the growth progress table T4200 to determine if there are other entries that have not yet been processed. In the case that there are other entries that have not yet been processed, the dynamic weight calculation process S4400 returns to Step S4420 and repeats the following steps. This process is repeated until all of the metric weights have been adapted based on the set of growth progress data. In the case that there are no other unprocessed entries, the dynamic weight calculation process S4400 ends at Step S4470.

In this way, according to the dynamic weight calculation process S4400, the set of metric weights for the set of solution performance metrics can be adapted based on the growth progress data obtained from this growth assessment in order to facilitate calculation of a contribution score for the solution owners that reflects the growth state of the digital ecosystem.

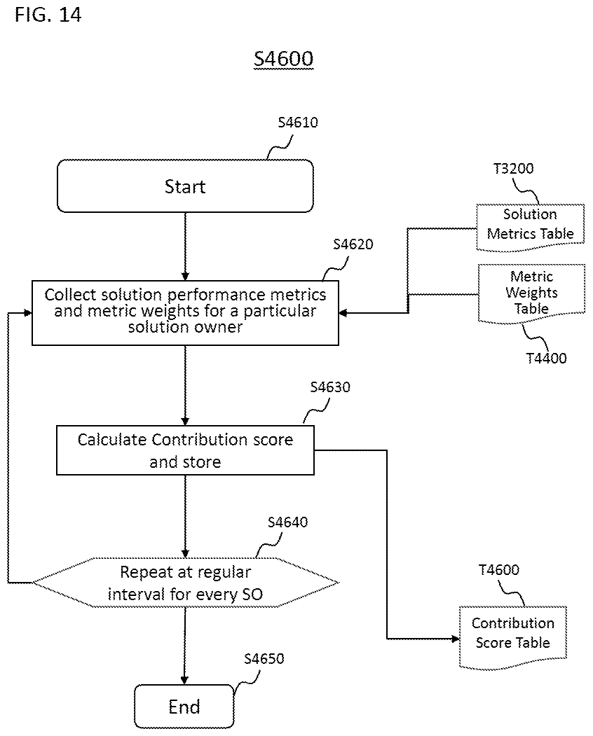

Next, the flow of a scoring process performed by the score calculation unit according to embodiments of the present disclosure will be described with reference to FIG. 14.

FIG. 14 is a flowchart illustrating the flow of a scoring process S4600 performed by the score calculation unit P4600 according to embodiments of the present disclosure. The scoring process S4600 is a process for calculating a contribution score for each solution owner based on the set of solution performance metrics and the set of metric weights. As illustrated in FIG. 14, the scoring process S4600 starts at Step S4610 and ends at Step S4650.

First, at Step S4620, the score calculation unit P4600 collects the set of solution performance metrics from the solution performance metrics table T3200 and the set of metric weights from the metric weights table T4400 for a particular solution owner. Here, the score calculation unit P4600 may collect a set of solution performance metrics and a set of metric weights for each solution contributed by a particular solution owner.

Next, at Step S4630, the score calculation unit P4600 calculates the contribution score for the solution owner based on the set of solution performance metrics and the set of metric weights (e.g., the set of metric weights adapted based on the growth progress data) collected for each solution contributed by the solution owner. In embodiments, the score calculation unit P4600 may calculate the contribution score for each solution owner as the sum of a weighted average of the set of solution performance metrics and the set of metric weights for each solution. More, particularly, the contribution score for an individual solution Cᵢ may be calculated using the following equation.

$${C}_{i} = \frac{( w 1 V 1 + w 2 V 2 + w 3 V3 + … wnVn )}{w 1 + w 2 + w3 + … wnVn} \qquad [ Equation 5 ]$$

Subsequently, the aggregate contribution score C_{T} for a solution owner may be calculated as the average score of each individual solution, as illustrated by the following equation.

$${C}_{T} = \frac{{C}_{i 1} + {C}_{i 2} + {C}_{i 3} + … {C}_{in}}{n} \qquad [ Equation 6 ]$$

Here, Cᵢ₁, Cᵢ₂, Cᵢ₃, Cᵢₙ represent the individual contribution scores for each solution calculated in Equation 5, w1, w2, w3, wn represent the set of metric weight values (e.g., the set of metric weight values T4430 stored in the metric weights table T4400 illustrated in FIG. 7), V1, V2, V3, Vn represent the set of solution performance metrics (e.g., the set of solution performance metrics T3240 stored in the solution performance metrics table T3200 illustrated in FIG. 4), and n represents the total number of solutions for the solution owner.

The score calculation unit P4600 stores the aggregate contribution score C_{T} calculated for the solution owner in the contribution score table T4600.

Next, at Step S4640, the score calculation unit P4600 checks the solution performance metrics table T3200 and the metric weights table T4600 to determine if there are other solution performance metrics or metric weights for other solution owners that have not yet been processed. In the case that there are other solution performance metrics or metric weights for other solution owners that have not yet been processed, the scoring process S4600 returns to Step S4620 and repeats the following steps. This process is repeated until a contribution score has been calculated for each solution owner. In the case that there are no other solution performance metrics or metric weights for other solution owners (e.g., a contribution score has been calculated for each solution owner), the scoring process 54600 ends at Step S4650.

By means of the scoring process 54600, contribution scores for solution owners that appropriately reflect the growth state of the digital ecosystem can be calculated. Based on these contribution scores, recommended actions for solution owners and recommended KPIs for platform managers can be generated to further facilitate growth of the digital ecosystem. Further, in certain embodiments, solution owners may be provided with incentives based on their contribution score. As an example, solution owners having greater contribution scores may receive greater financial compensation (e.g., greater portion of profits) for their solutions. Other types of incentives based on the contribution score are also possible.

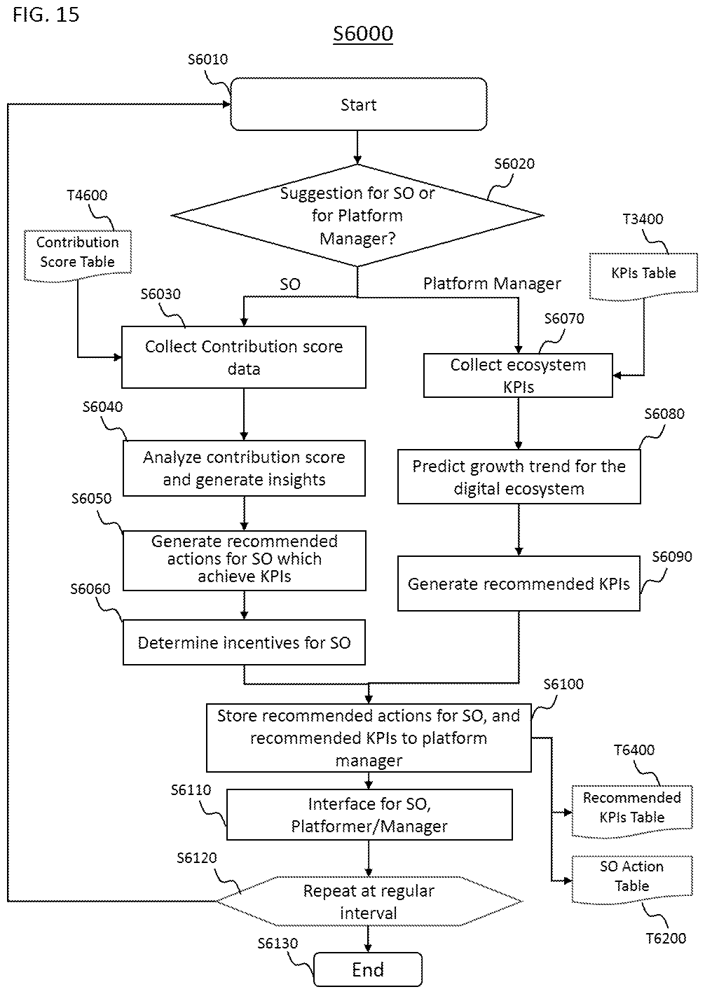

Next, the flow of a solution owner action and KPI suggestion process performed by the solution owner action and KPI suggestion unit according to embodiments of the present disclosure will be described with reference to FIG. 15.

FIG. 15 is a flowchart illustrating the flow of a solution owner action and KPI suggestion process S6000 performed by the solution owner action and KPI suggestion unit P6000 according to embodiments of the present disclosure. The solution owner action and KPI suggestion process S6000 is a process for generating a set of recommended actions for the solution owner and generating a set of recommended KPIs for the platform manager. As illustrated in FIG. 15, the solution owner action and KPI suggestion process S6000 starts at Step S6010 and ends at Step S6130.

First, at Step S6020, the solution owner action and KPI suggestion unit P6000 determines whether to generate suggestions for the solution owner or the platform manager. This determination may be performed based on data availability, or a pre-defined priority criterion (e.g., instruction to prioritize generation of either the suggestions for the solution owner or the platform manager, or whether recommended actions or recommended KPIs have already been generated for this data set). In the case that the suggestions are to be generated for the solution owner, the solution owner action and KPI suggestion process S6000 proceeds to Step S6030. In the case that the suggestions are to be generated for the platform manager, the solution owner action and KPI suggestion process S6000 proceeds to Step S6070.

In the case that it is determined that suggestions are to be generated for the solution owner, at Step S6030, the solution owner action and KPI suggestion unit P6000 collects the contribution scores from the contribution score table T4600.

Next, at Step S6040, the solution owner action and KPI suggestion unit P6000 analyzes the contribution score for each solution owner to generate insights. Here, these insights can be generated by comparing the contribution score for each solution owner to the contribution scores for other solution owners or past contribution scores for the same solution owner to ascertain areas in which the contribution score can be improved (e.g., increase number of solutions, increase expected profit yielded by solutions or the like). In embodiments, these insights can be generated using a deep learning technique or other artificial intelligence computing technique.

Next, at Step S6050, the solution owner action and KPI suggestion unit P6000 generates a set of recommended actions for the solution owner that achieve the set of ecosystem KPIs based on the analysis of Step S6040. As described herein, the set of recommended actions may include one or more activities that can be performed by the solution owner in order to facilitate an increase in their own contribution score and facilitate growth of the digital ecosystem. As examples, the set of recommended actions may include “Increase the number of solutions contributed to the digital ecosystem,” “Increase the expected profit of solutions,” “Add more solutions related to [Domain1]” or the like. In embodiments, the set of recommended actions may be generated by using the insights from the analysis of Step S6040 together with a look-up table that defines recommended actions for a variety of different scenarios.

Next, at Step S6060, the solution owner action and KPI suggestion unit P6000 determines a set of incentives for the solution owner. Here, the set of incentives may include rewards designed to motivate the solution owner to perform the set of recommended actions determined in Step S6050. As examples, the set of incentives may include greater financial compensation (e.g., a greater portion of profits) for particular solutions, or additional advertising in the digital ecosystem for solutions contributed by the solution owner. The set of incentives can be determined for the solution owner based on the recommended actions, the contribution score for the solution owner, and look-up tables that define appropriate incentives for the solution owner for given recommended actions and/or contribution scores.

In the case that it is determined that suggestions are to be generated for the platform owner, at Step S6070, the solution owner action and KPI suggestion unit P6000 collects the set of ecosystem KPIs from the KPIs table T3400.

At Step S6080, the solution owner action and KPI suggestion unit P6000 predicts a growth trend for the digital ecosystem based on set of growth progress data. More particularly, the solution owner action and KPI suggestion unit P6000 may analyze the set of growth progress data for a current time period and past time periods to ascertain a growth trend of the digital ecosystem over time. As described herein, the growth trend may include a quantitative indication of the rate of growth (e.g., in terms of profit, number of solutions, or other characteristic) of the digital ecosystem.

Next, at Step S6090, the solution owner action and KPI suggestion unit P6000 generates a set of recommended KPIs based on the growth trend of the digital ecosystem predicted in Step S6080 and the set of ecosystem KPIs. As described herein, the recommended KPIs may be KPIs recommended by the contribution management system to facilitate continued growth of the digital ecosystem. In embodiments, the solution owner action and KPI suggestion unit P6000 may use the growth trend of the digital ecosystem to predict the future growth of the digital ecosystem, and apply the growth trend to the set of ecosystem KPIs to determine a set of recommended KPIs in accordance with the anticipated growth of the digital ecosystem.

Next, at Step S6100, the solution owner action and KPI suggestion unit P6000 may generate the solution owner action table T6200 and store the set of recommended actions in this solution owner action table T6200, and generate the recommended KPIs table T6400 and store the set of recommended KPIs in this recommended KPIs table T6400.

Next, at Step S6110, the solution owner action and KPI suggestion unit P6000 may provide the set of recommended actions to the solution owner via the solution owner interface, and provide the set of recommended KPIs to the platform owner via the platform manager interface. In this way, the solution owner can confirm the recommended actions, and the platform owner can confirm the recommended KPIs for facilitating continued growth of the digital ecosystem.

Next, at Step S6120, the solution owner action and KPI suggestion unit P6000 checks the contribution score table T4600 and the KPIs table T3400 to determine if there are other contribution scores or KPIs that have not yet been processed. In the case that there are other contribution scores or KPIs that have not yet been processed, the solution owner action and KPI suggestion process S6000 returns to Step S6010 and repeats the following steps. This process is repeated until all the contribution scores and KPIs have been processed to generate recommended actions and recommended KPIs. In the case that there are no other contribution scores or KPIs, solution owner action and KPI suggestion process S6000 ends at Step S6130.

By means of the solution owner action and KPI suggestion process S6000, recommended actions for solution owners and recommended KPIs for platform managers can be generated and provided. Based on these recommendations, both solution owners and platform managers can make changes to the digital ecosystem (e.g., contribute new solutions, set new KPIs) that facilitate continued growth of the digital ecosystem.

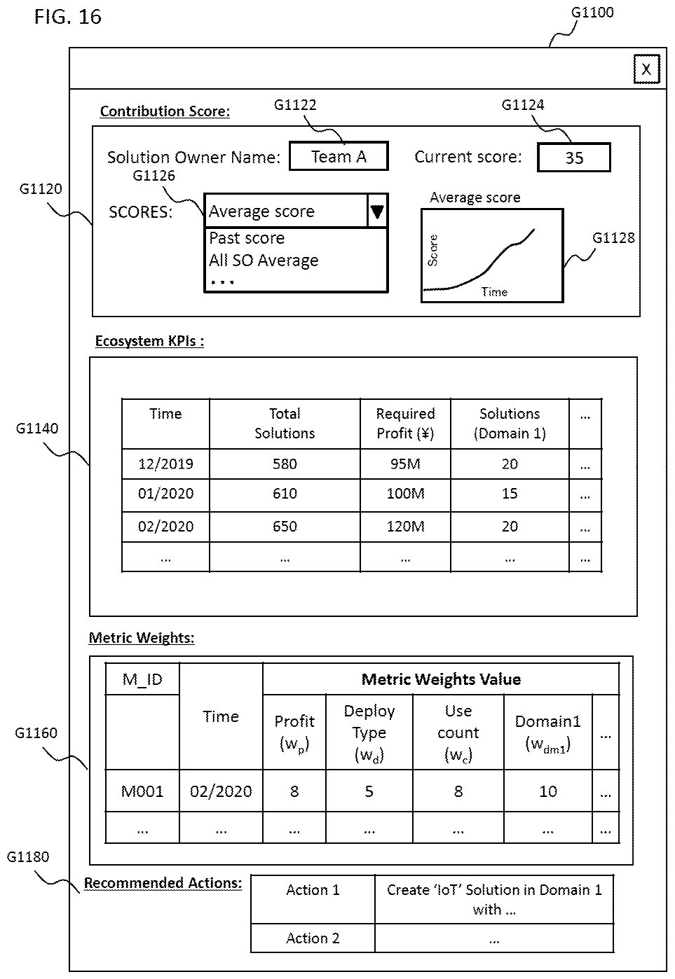

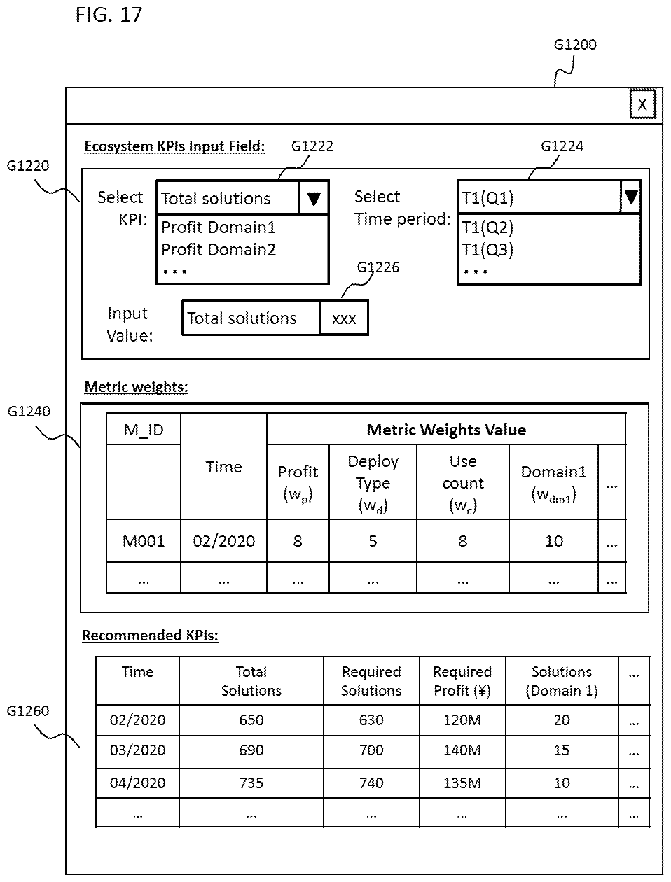

Next, a solution owner interface according to embodiments of the present disclosure will be described with respect to FIG. 16, and a platform manager interface will be described with respect to FIG. 17.

FIG. 16 illustrates a solution owner interface G1100 according to embodiments of the present disclosure. As described herein, the solution owner interface G1100 is a graphical user interface that can be used by the solution owner to confirm the analysis of their contribution score, the set of metric weights, and the set of recommended actions.

As illustrated in FIG. 16, the solution owner interface G1100 includes a contribution score display G1120, an ecosystem KPI display G1140, a metric weights display G1160, and a recommended actions display G1180.

Using the contribution score display G1120, the solution owner can confirm his or her solution owner name G1122, current contribution score G1124, and other details regarding the contribution score. For instance, by making a selection from drop-down menu G1126, the solution owner can view a graph G1128 illustrating the average contribution score for a certain period of time, the average contribution score among other solution owners, or the like.

Using the ecosystem KPI display G1140, the solution owner can see the ecosystem KPIs for a particular time. Here, the ecosystem KPIs displayed in the ecosystem KPI display G1140 may be fetched from the KPIs table T3400.

Using the metric weights display G1160, the solution owner can see the set of metric weights adapted based on the growth progress data for a particular time. Here, the metric weights displayed in the metric weights display G1160 may be fetched from the metric weights table T4400.

Using the recommended actions display G1180, the solution owner can confirm the set of recommended actions suggested to them based on their contribution score. As an example, the recommended actions may include an action of “Create ‘IoT’ solution in Domain 1 with [characteristic].” Here, the set of recommended actions displayed in the recommended actions display G1180 may be fetched from the solution owner action table T6200.

FIG. 17 illustrates a platform manager interface G1200 according to embodiments of the present disclosure. As described herein, the platform manager interface G1200 is a graphical user interface that can be used by the platform manager of the digital ecosystem to input the set of ecosystem KPIs, confirm the set of metric weights, and confirm the set of recommended KPIs.

As illustrated in FIG. 17, the platform manager interface G1200 includes an ecosystem KPIs input field G1220, a metric weights display G1240, and a recommended KPIs display G1260.

Using the ecosystem KPIs input field G1220, the platform manager can input the set of ecosystem KPIs to the digital ecosystem. More particularly, the platform manager can select a particular KPI from the drop-down menu G1222, select a time period of validity for this particular KPI from the drop-down menu G1224, and set an input value for the selected KPI using the menu G1226. Here, the ecosystem KPIs set by the platform manager are stored to the KPIs table T3400 described herein.

Using the metric weights display G1240, the platform manager can see the adapted set of metric weights for a particular time. Here, the metric weights displayed in the metric weights display G1240 may be fetched from the metric weights table T4400.

Using the recommended KPIs display G1260, the platform manager can confirm the set of recommended KPIs suggested based on the analysis of the contribution scores for the solution owners. In embodiments, the platform owner may set the ecosystem KPIs in the ecosystem KPIs input field G1220 based on the set of recommended KPIs displayed in the recommended KPIs display G1260. Here, the set of recommended KPIs displayed in the recommended KPIs display G1260 may be fetched from the recommended KPIs table T6400.

By means of the solution owner interface G1100 illustrated in FIG. 16 and the platform owner interface G1200 illustrated in FIG. 17, recommended actions for solution owners and recommended KPIs for platform managers can be generated and provided. Based on these recommendations, both solution owners and platform managers can make changes to the digital ecosystem (e.g., contribute new solutions, set new KPIs) that facilitate continued growth of the digital ecosystem.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. “Set of,” “group of,” “bunch of,” etc. are intended to include one or more. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the various embodiments, reference was made to the accompanying drawings (where like numbers represent like elements), which form a part hereof, and in which is shown by way of illustration specific exemplary embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

### REFERENCE SIGNS LIST

100 . . . Computer system
102 . . . Processor
104 . . . Memory
106 . . . Memory bus
108 . . . I/O bus
109 . . . Bus IF
110 . . . I/O Bus IF
112 . . . Terminal interface
113 . . . Storage interface
114 . . . I/O device interface
115 . . . Network interface
116 . . . User I/O device
117 . . . Storage device
124 . . . Display system
126 . . . Display
130 . . . Network
150 . . . Contribution management application
500 . . . Contribution management system
1000 . . . User interface unit
2000 . . . Ecosystem environment unit
2100 . . . Solution registration unit
2200 . . . Solution catalog unit
2300 . . . Solution management unit
2400 . . . Ecosystem KPI unit
3000 . . . Data collection unit
4000 . . . Contribution measurement unit
6000 . . . Suggestion unit
G1100 . . . SO interface
G1200 . . . Platform manager interface
N100, N200, N300 . . . Communication network connection
P3000 . . . Metrics and KPI collection unit
P4200 . . . Growth assessment unit
P4400 . . . Dynamic weight calculation unit
P4600 . . . Contribution score table
P6000 . . . SO action and KPI suggestion unit
T3200 . . . Solution metrics table
T3400 . . . KPIs table
T4200 . . . Growth progress table
T4400 . . . Metric weights table
T4600 . . . Contribution score table
T6200 . . . SO action table
T6400 . . . Recommended KPIs table

What is claimed is:

1. A contribution management device for managing a contribution of a solution owner in a digital ecosystem, the contribution management device comprising:
a data collection unit configured to:
collect a first set of solution performance metrics for a first digital solution submitted to the digital ecosystem by a solution owner, and
collect, from a platform manager of the digital ecosystem, a set of ecosystem key performance indicators that indicate operational targets for the digital ecosystem;
a contribution measurement unit configured to calculate a first contribution score for the first digital solution based on the first set of solution performance metrics and a first set of metric weights for the first set of solution performance metrics; and
a suggestion unit configured to generate, based on the first contribution score and the set of ecosystem key performance indicators, a set of recommended actions for increasing growth of the digital ecosystem, and output the set of recommended actions,
wherein:
the contribution measurement unit further includes a growth assessment unit configured to generate a set of growth progress data for the digital ecosystem based on the first set of solution performance metrics and the set of ecosystem key performance indicators, and
a dynamic weight calculation unit configured to calculate the first set of metric weights based on the set of growth progress data.

2. The contribution management device according to claim 1, wherein the growth assessment unit is configured to:
compare the set of solution performance metrics and the set of ecosystem key performance indicators to calculate a growth deficit for each solution performance metric of the set of solution performance metrics that indicates a difference between a current growth state and a desired growth state; and
generate the set of growth progress data by aggregating the growth deficit for each solution performance metric of the set of solution performance metrics.

3. The contribution management device according to claim 1, wherein the contribution measurement unit is further configured to:
calculate a second contribution score for a second digital solution submitted to the digital ecosystem by the solution owner based on a second set of solution performance metrics and a second set of metric weights for the second digital solution; and
calculate, based on the first contribution score and the second contribution score, an aggregate contribution score indicating a contribution level of the solution owner to the digital ecosystem using a weighted average operation.

4. The contribution management device according to claim 3, wherein the dynamic weight calculation unit is further configured to:
determine, by analyzing the set of growth progress data, a growth trend that indicates a rate of growth of the digital ecosystem;
generate, using the growth trend and the set of ecosystem KPIs, a growth function to model the rate of growth of the digital ecosystem with respect to one or more solution performance metrics of the set of solution performance metrics; and
calculate the first set of metric weights using the growth function.

5. The contribution management device according to claim 4, wherein the suggestion unit is further configured to:
generate, based on the growth trend and the set of ecosystem KPIs, a set of recommended key performance indicators for increasing growth of the digital ecosystem.

6. The contribution management device according to claim 5, further comprising a user interface unit configured to:
provide, to the solution owner, a solution owner interface screen indicating the aggregate contribution score, the set of ecosystem key performance indicators, the first set of metric weights, and the set of recommended actions; and
provide, to a platform manager of the digital ecosystem, a platform manager interface screen for receiving input of the set of ecosystem key performance indicators and for displaying the first set of metric weights and the set of recommended key performance indicators.

7. A contribution management method for managing a contribution of a solution owner in a digital ecosystem, the contribution management method comprising:
collecting, from a solution owner, a first set of solution performance metrics for a first digital solution submitted to the digital ecosystem by the solution owner;
collecting, from a platform manager of the digital ecosystem, a set of ecosystem key performance indicators that indicate operational targets for the digital ecosystem;
generating a set of growth progress data for the digital ecosystem based on the first set of solution performance metrics and the set of ecosystem key performance indicators;
calculating a first set of metric weights for the first set of solution performance metrics based on the set of growth progress data;
calculating a first contribution score for the first digital solution based on the first set of solution performance metrics and the first set of metric weights; and
generating, based on the first contribution score and the set of ecosystem key performance indicators, a set of recommended actions for increasing growth of the digital ecosystem; and
outputting, via a solution owner interface, the set of recommended actions to the solution owner.

8. A contribution management system for managing a contribution of a solution owner in a digital ecosystem, the contribution management system comprising:
a solution owner interface for receiving and presenting data with respect to the solution owner;
a platform manager interface for receiving and presenting data with respect to a platform manager of the digital ecosystem;
a data collection unit configured to:
collect, via the solution owner interface, a first set of solution performance metrics for a first digital solution submitted to the digital ecosystem by the solution owner, and
collect, via the platform owner interface, a set of ecosystem key performance indicators that indicate operational targets for the digital ecosystem;
a contribution measurement unit configured to calculate a first contribution score for the first digital solution based on the first set of solution performance metrics and a first set of metric weights for the first set of solution performance metrics; and
a suggestion unit configured to generate, based on the first contribution score and the set of ecosystem key performance indicators, a set of recommended actions for increasing growth of the digital ecosystem, and output the set of recommended actions via the solution owner interface,
wherein:
the contribution measurement unit further includes a growth assessment unit configured to generate a set of growth progress data for the digital ecosystem based on the first set of solution performance metrics and the set of ecosystem key performance indicators, and
a dynamic weight calculation unit configured to calculate the first set of metric weights based on the set of growth progress data.

9. The contribution management system according to claim 8, wherein the dynamic weight calculation unit is further configured to:
determine, by analyzing the set of growth progress data, a growth trend that indicates a rate of growth of the digital ecosystem;
generate, using the growth trend and the set of ecosystem KPIs, a growth function to model the rate of growth of the digital ecosystem with respect to one or more solution performance metrics of the set of solution performance metrics; and
calculate the first set of metric weights using the growth function.

10. The contribution management system according to claim 9, wherein the suggestion unit is further configured to:
generate, based on the growth trend and the set of ecosystem KPIs, a set of recommended key performance indicators for increasing growth of the digital ecosystem.

11. The contribution management system according to claim 10, wherein the suggestion unit is further configured to:
output, via the platform manager interface, the set of recommended key performance indicators.
